(19) United States
(12) Patent Application Publication
(10) Pub. No.: US 2014/0153358 A1
(43) Pub. Date: Jun. 5, 2014

(54) MEDICAL IMAGING SYSTEM AND METHOD FOR PROVIDING IMAGING ASSITANCE

(71) Applicant: General Electric Company, Schenectady, NY (US)

(72) Inventors: Kalyanaraman Balakrishnan, Bangalore (IN); Ajay Parkhe, Bangalore (IN); Madhumita Gupta, Bangalore (IN)

(73) Assignee: General Electric Company, Schenectady, NY (US)

(21) Appl. No.: 14/092,268

(22) Filed: Nov. 27, 2013

(30) Foreign Application Priority Data
Nov. 30, 2012 (IN) 5016/CHE/2012

(51) Int. Cl. G01S 15/02

(52) U.S. Cl. CPC G01S 15/02
USPC 367/7

(57) ABSTRACT

A medical imaging system capable of providing assistance to a user for acquiring medical images. The medical imaging system includes an image acquisition unit configured to acquire a live medical image of an object in a scanning plane. An image assistance unit is configured to present at least one of one or more reference images in the scanning plane of the live medical image. The image assistance unit also presents at least one demonstration image clip for obtaining the at least one reference image using the image acquisition unit. A display unit is communicably coupled to the image acquisition unit and the imaging assistance unit. The display unit is configured to display the at least one reference image and the at least one demonstration image clip along with the live medical image.

### TECHNICAL FIELD

The subject matter disclosed herein relates to a medical imaging system. More specifically the subject matter relates to a method of providing imaging assistance to a user of the medical imaging system for acquiring medical images.

### BACKGROUND OF THE INVENTION

Medical imaging systems are used in different applications to image different regions or areas (e.g. different organs) of patients or other objects. For example, an ultrasound imaging system may be utilized to generate an image of organs, vasculature, heart, or other portions of the body. Ultrasound imaging systems are generally located at a medical facility, for example, a hospital or imaging center. Using an ultrasound imaging system for acquiring images (i.e. medical images) requires suitable technical expertise and training Thus specialized technicians are required and they undergo training for operating these imaging systems. The modes of training that are commonly used include classroom trainings, training books, or other online training materials.

While using the medical imaging system a technician may have to refer some training materials (i.e. offline or online training materials) to understand procedures to be followed or as a guidance for performing an image procedure. For instance for determining a fetal biometry and wellbeing of a subject, gestational age and fetal size may need to be determined. For this reason different imaging parameters such as, biparietal diameter (BPD), head circumference (HC), abdominal circumference (AC) and femur diaphysis length (FDL) need to be analyzed or measured. The technician may need to check for these imaging parameters time to time from training materials or technical books for guidance that makes the procedure time consuming and laborious for the technician.

Thus there is a need for a system that can assist a user (i.e. technician) in acquiring a medical image efficiently using a medical imaging system.

### BRIEF DESCRIPTION OF THE INVENTION

The above-mentioned shortcomings, disadvantages and problems are addressed herein which will be understood by reading and understanding the following specification.

As discussed in detail below, embodiments of the invention include a medical imaging system capable of providing assistance to a user for acquiring medical images is disclosed. The medical imaging system includes an image acquisition unit configured to acquire a live medical image of an object in a scanning plane. An image assistance unit is configured to present one or more reference images in the scanning plane of the live medical image. The image assistance unit also presents at least one demonstration image clip for obtaining the at least one reference image using the image acquisition unit. A display unit is communicably coupled to the image acquisition unit and the imaging assistance unit. The display unit is configured to display the at least one reference image and the at least one demonstration image clip along with the live medical image.

In another embodiment a method of assisting a user in acquiring a medical image of an object using a medical imaging system is disclosed. The method includes acquiring a live medical image of the object in a scanning plane; presenting at least one reference image in the scanning plane of the live medical image; and displaying at least one demonstration image clip for obtaining the at least one reference image using an image acquisition unit of the medical imaging system. The at least one reference image and the at least one demonstration image clip are displayed along with the live medical image.

### BRIEF DESCRIPTION OF THE DRAWINGS

FIG. 1 is a schematic illustration of an ultrasound imaging system in accordance with an embodiment;

FIG. 2 is a schematic illustration of a medical imaging system for providing imaging assistance to a user in accordance with an embodiment;

FIG. 3 is a schematic illustration of a user interface of the medical imaging system in accordance with an embodiment;

FIG. 4 is a schematic illustration of the user interface of the medical imaging system;

FIG. 5 is a schematic illustration of multiple image frames of a window presented in the user interface in accordance with an embodiment;

FIG. 6 is a schematic illustration of an error image along with a set of instructions displayed in the user interface in accordance with an exemplary embodiment;

FIG. 7 illustrates a block diagram of a method of assisting a user in acquiring a medical image of an object using a medical imaging system in accordance with an embodiment; and

FIGS. 8A and 8B illustrate a block diagram of a method of assisting a user in acquiring a medical image of an object using a medical imaging system in accordance with another embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

To the extent that the figures illustrate diagrams of the functional blocks of various embodiments, the functional blocks are not necessarily indicative of the division between hardware circuitry. One or more of the functional blocks (e.g., processors or memories) may be implemented in a single piece of hardware (e.g., a general purpose signal processor or random access memory, hard disk, or the like) or multiple pieces of hardware. Similarly, the programs may be standalone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

A medical imaging system capable of providing assistance to a user for acquiring medical images is disclosed. The medical imaging system includes an image acquisition unit configured to acquire a live medical image of an object in a scanning plane. An image assistance unit is configured to present one or more reference images in the scanning plane of the live medical image. The image assistance unit also presents at least one demonstration image clip for obtaining the at least one reference image using the image acquisition unit. A display unit is communicably coupled to the image acquisition unit and the imaging assistance unit. The display unit is configured to display the at least one reference image and the at least one demonstration image clip along with the live medical image.

Although the various embodiments are described with respect to an ultrasound imaging system, the various embodiments may be utilized with any suitable medical imaging system, for example, X-ray, computed tomography, single photon emission computed tomography, magnetic resonance imaging, or the like.

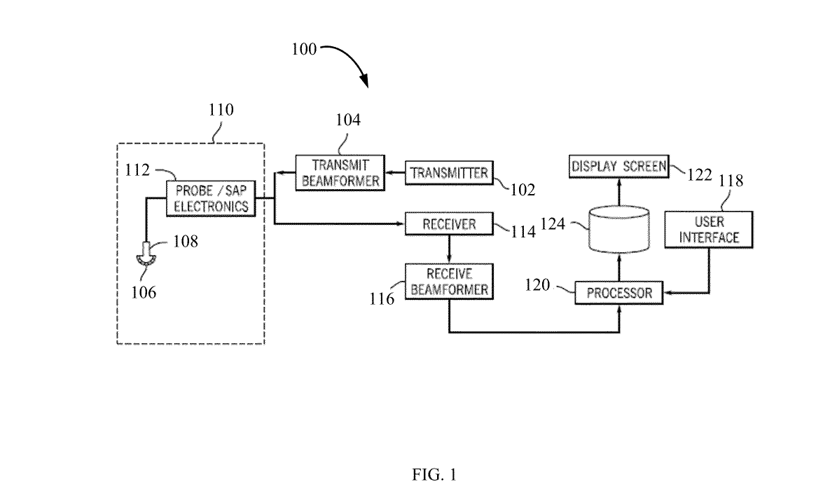

FIG. 1 is a schematic illustration of an ultrasound imaging system 100 in accordance with an embodiment. The ultrasound imaging system 100 includes a transmitter 102 that transmits a signal to a transmit beam-former 104 which in turn drives transducer elements 106 within a transducer array 108 to emit pulsed ultrasonic signals into a structure, such as a patient (not shown). A probe 110 includes the transducer array 108, the transducer elements 106 and probe/SAP electronics 112. The probe/SAP electronics 112 may be used to control the switching of the transducer elements 106. The probe/SAP electronics 112 may also be used to group the transducer elements 104 into one or more sub-apertures. A variety of geometries of transducer arrays may be used. The pulsed ultrasonic signals are back-scattered from structures in the body, like blood cells or muscular tissue, to produce echoes that return to the transducer elements 106. The echoes are converted into electrical signals, or ultrasound data, by the transducer elements 106 and the electrical signals are received by a receiver 114. For purposes of this disclosure, the term ultrasound data may include data that was acquired and/or processed by an ultrasound system. The electrical signals representing the received echoes are passed through a receive beam-former 116 that outputs ultrasound data. A user interface 118 may be used to control operation of the ultrasound imaging system 100, including, to control the input of patient data, to change a scanning or display parameter, and the like.

The ultrasound imaging system 100 also includes a processor 120 to process the ultrasound data and generate frames or images for display on a display screen 122. The processor 120 may be adapted to perform one or more processing operations according to a plurality of selectable ultrasound modalities on the ultrasound data. Other embodiments may use multiple processors to perform various processing tasks. The processor 120 may also be adapted to control the acquisition of ultrasound data with the probe 110. The ultrasound data may be processed in real-time during a scanning session as the echo signals are received. An embodiment may update the displayed ultrasound image at a rate of more than 20 times per second. The images may be displayed as part of a live medical image. For purposes of this disclosure, the term “live medical image” is defined to include a dynamic image that updates as additional frames of ultrasound data are acquired. For example, ultrasound data may be acquired even as images are being generated based on previously acquired data and while a live medical image is being displayed. Then, according to an embodiment, as additional ultrasound data are acquired, additional frames or images generated from more-recently acquired ultrasound data are sequentially displayed. Additionally or alternatively, the ultrasound data may be stored temporarily in a buffer (not shown) during a scanning session and processed in less than real-time in a live or off-line operation. Some embodiments of the invention may include multiple processors (not shown) to handle the processing tasks. For example, a first processor may be utilized to demodulate and decimate the ultrasound signal while a second processor may be used to further process the data prior to displaying an image. It should be appreciated that other embodiments may use a different arrangement of processors.

The images may be obtained or acquired at different scanning planes based on an imaging procedure that is performed. The imaging procedure may be for example fetal biometry and wellbeing assessment, fetal anatomical survey, abdominal scanning, and cardiac scanning Considering the case of fetal anatomical survey, various imaging parameters may be accessed such as head, face, neck, chest/heart, abdomen, skeletal, placenta and umbilical cord. The imaging parameters in this case are body parts and/or organs of a fetus. The images are acquired from different scanning planes such as but not limited to, an axial plane, a transventricular plane, a transthalamic plane, a transcerebellar plane, a coronal plane, a sagittal plane and a mid-sagittal plane. The imaging parameters vary depending on the imaging procedure selected by the user. For instance to perform fetal biometry and wellbeing assessment, imaging parameters such as a biparietal diameter, a head circumference, an abdominal circumference and a femur diaphysis length may be analyzed using the ultrasound imaging system 100.

Still referring to FIG. 1, the ultrasound imaging system 100 may continuously acquire ultrasound data at a frame rate of, for example, 20 Hz to 150 Hz. However, other embodiments may acquire ultrasound data at a different rate. A memory 124 is included for storing processed frames of acquired ultrasound data that are not scheduled to be displayed immediately. In an exemplary embodiment, the memory 124 is of sufficient capacity to store at least several seconds worth of frames of ultrasound data. The frames of ultrasound data are stored in a manner to facilitate retrieval thereof according to its order or time of acquisition. As described hereinabove, the ultrasound data may be retrieved during the generation and display of a live medical image. The memory 124 may comprise any known data storage medium.

In various embodiments of the present invention, ultrasound information may be processed by other or different mode-related modules (e.g., B-mode, Color Doppler, power Doppler, M-mode, spectral Doppler anatomical M-mode, strain, strain rate, and the like) to form 2D or 3D data sets of image frames and the like. For example, one or more modules may generate B-mode, color Doppler, power Doppler, M-mode, anatomical M-mode, strain, strain rate, spectral Doppler image frames and combinations thereof, and the like. The image frames are stored and timing information indicating a time at which the image frame was acquired in memory may be recorded with each image frame. The modules may include, for example, a scan conversion module to perform scan conversion operations to convert the image frames from Polar to Cartesian coordinates. A video processor module may be provided that reads the image frames from a memory and displays the image frames in real time while a procedure is being carried out on a patient. A video processor module may store the image frames in an image memory, from which the images are read and displayed. The ultrasound imaging system 100 shown may comprise a console system, or a portable system, such as a hand-held or laptop-type system.

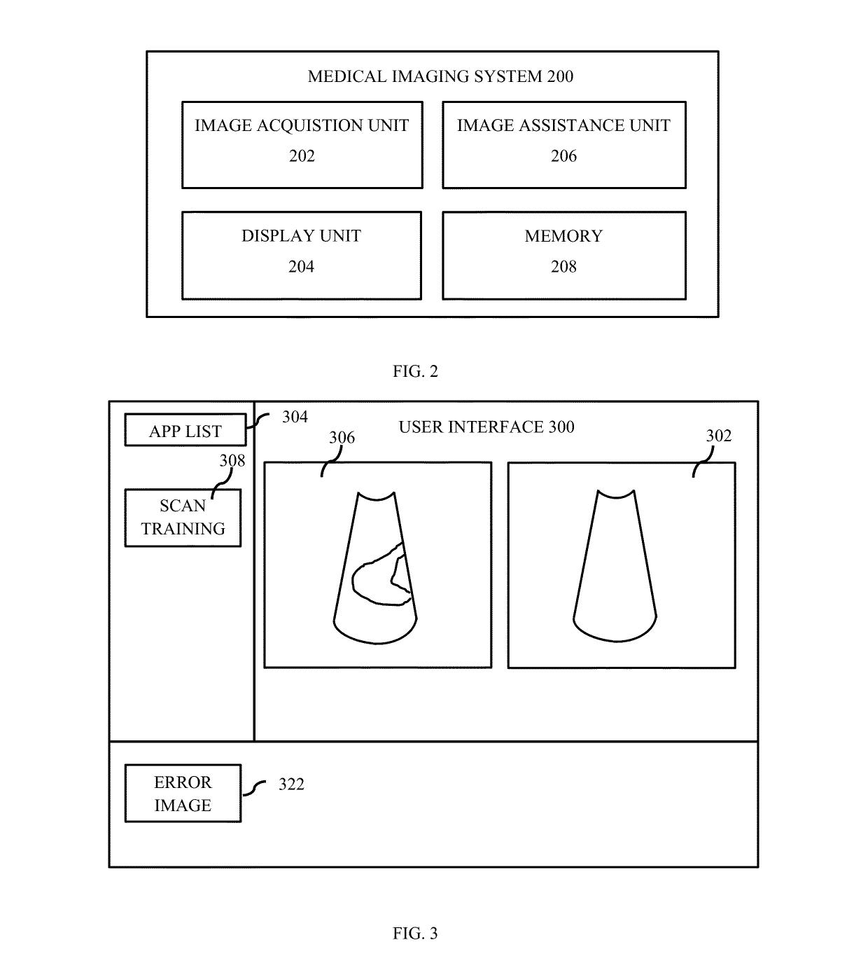

FIG. 2 illustrates a medical imaging system 200 for providing imaging assistance to a user in accordance with an embodiment. The medical imaging system 200 includes an image acquisition unit 202 configured to acquire a live medical image of an object in a scanning plane. The scanning plane as discussed in FIG. 1 includes an axial plane, a transventricular plane, a transthalamic plane, a transcerebellar plane, a coronal plane, a sagittal plane and a mid-sagittal plane. The scanning plane depends on the imaging procedure selected by the user. The object may be an anatomy or organ of a subject i.e., a patient and an animal that needs to be examined. The live medical image is displayed through the display unit 204 so that a user of the medical imaging system 200 can view. The display unit 204 is communicably coupled to the image acquisition unit 202. The user will prefer an image that can provide sufficient details for analyzing the health condition of the object. In order to provide assistance an imaging assistance unit 206 presents one or more reference images in the scanning plane of the live medical image. Thus the imaging assistance unit 206 determines the scanning plane based on the image procedure selected. Consequently the one or more reference images in the scanning plane are retrieved from a memory 208. A reference image may be an image in the selected scanning plane that includes sufficient details of the anatomy. The reference image is part of a plurality of reference images stored in the memory 208. The plurality of reference images may be associated with different scanning planes. The plurality of reference images may be collected based on various imaging procedures performed earlier by different users and also from different training materials. The plurality of reference images also includes images that may be present in training manuals of the technician and other medical imaging textbooks. The memory 208 may be frequently updated with more reference images. In an embodiment reference images may be retrieved from an external storage connected to the medical imaging system 200. The user can view the one or more reference images presented through the display unit 204 and use the image acquisition unit 202 to acquire these reference images as a live medical image.

The imaging assistance unit 206 also provides one or more demonstration image clips for obtaining the one or more reference images using the image acquisition unit 202. A demonstration image clip may be a video, a streaming video and/or images. The demonstration image clip may be displayed along with the one or more reference images and the live medical image. The demonstration image clip may show multiple steps involved in acquiring the one or more reference images using the image acquisition unit 202 and a schematic representation of the one or more reference images. This demonstration image clip helps the user to adjust and/or move the image acquisition unit 202 to obtain the reference image. If the user is a trained technician then the user can easily recognize the steps displayed and adjust the image acquisition unit 202 to acquire the reference image. Whereas a novice user can view the demonstration image clip and learn image acquisition steps that need to performed and get trained for performing the imaging procedure. Thus the demonstration image clip acts as a training guidance for the user of the medical imaging system 200.

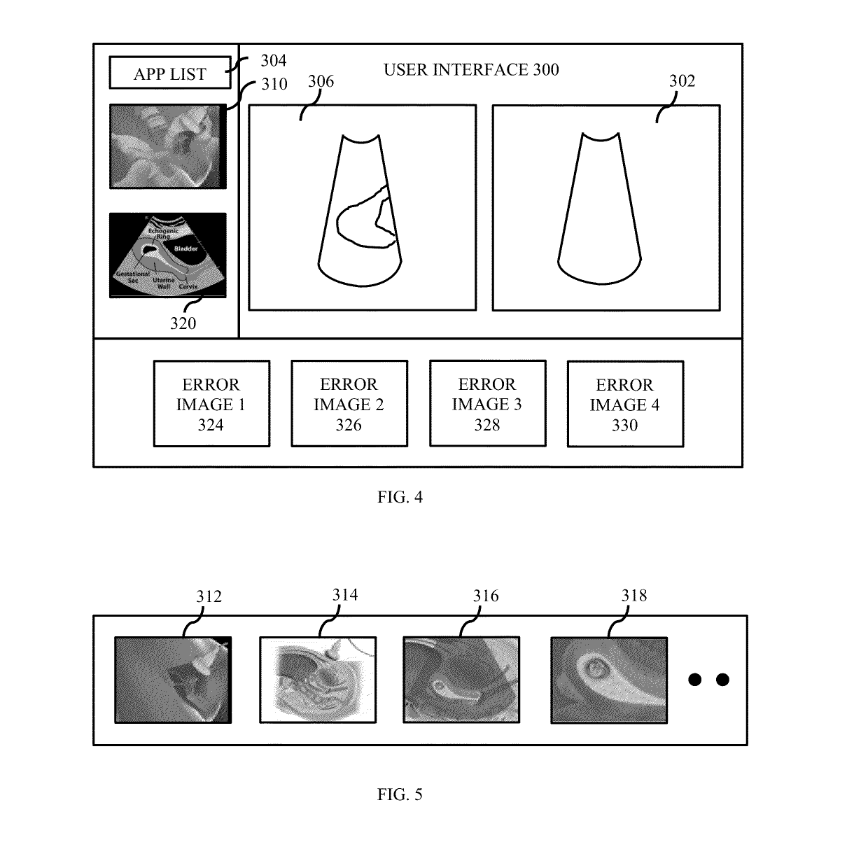

FIG. 3 and FIG. 4 illustrate a user interface 300 of the medical imaging system 200 in accordance with an exemplary embodiment. The user interface 300 presents a live medical image 302 obtained from a subject using the image acquisition unit 202. The live medical image 302 is obtained in a scanning plane associated with the imaging procedure selected by the subject. The selected imaging procedure is an abdominal imaging procedure. The abdominal imaging procedure is selected using an app list button 304 in the user interface 300. The app list button 304 when selected or clicked by the user lists out multiple application procedures. The user can select the abdominal imaging procedure from this list. In an embodiment the user interface 300 may display multiple imaging procedures as a menu item when the app list button 304 is selected. The user or technician can select from the listed multiple imaging procedures. These imaging procedures may have their respective image protocols. An imaging protocol defines image processing steps, one or more imaging parameters and one or more scanning planes in which images need to be captured. In an instance the image processing steps may also be displayed in the user interface 300. When the imaging procedure is selected an imaging protocol associated with the imaging procedure is loaded. This imaging protocol includes the scanning plane of the selected imaging procedure. A reference image 306 is identified from the plurality of reference images and displayed in the user interface 300. The reference image 306 is associated with a portion of the abdomen or whole abdomen. The reference image 306 enables the user to observe this image and operate the image acquisition unit 202 to obtain a medical image closer to or similar to the reference image. The user may also take more assistance by activating a scan training button 308. The scan training button 308 when activated displays a demonstration image clip showing the procedures involved in using the image acquisition unit 202 and medical images obtained by following these procedures.

In an embodiment the demonstration image clip is shown in multiple display windows. For instance as shown in FIG. 4 a first window 310 displays positioning of an image acquisition unit such as a probe on a subject's or patient's body part. This window displays the positioning of the image acquisition unit on the subject's body part for acquiring the reference image 306. The content displayed in the first window may be a static image or a video. In an embodiment the content may be displayed as a flash video. In an embodiment the content displayed may in a three dimensional (3-D) form. The content shown through the first window 310 may be present in one or more of a single image frame and multiple image frames. Thus as shown in FIG. 5, the first window 310 displays four image frames. A first image frame 312 displays positioning of the image acquisition unit on the subject's body part in a particular scanning plane to obtain the reference image 306. Moreover orientation of the image acquisition unit to the subject's body can be analyzed by the user. A second image frame 314 presents a three dimensional (3-D) animated content of positioning of the image acquisition unit. This animated content helps the user in understanding the procedure to be followed for positioning the image acquisition unit on the subject's body. A zoomed-in view of the 3-D animated content is displayed on a third image frame 316. In a scenario the zoomed-in view also presents an internal structure of the subject's body part with respect to the position of the image acquisition unit. This image frame clearly indicates orientation of the image acquisition unit with respect to the organ of the subject to acquire the reference image of the organ. Further a fourth image frame 318 presents formation of the imaging rays of the image acquisition unit through the subject's body. For example in the case of an ultrasound imaging system, the probe may generate an ultrasound beam that passes through the subject to reach a target organ. This beam formation associated with the ultrasound beam and its orientation with respect to internal organs of the subject can be viewed by the user to understand the orientation of the probe with respect to the subject's body. The beam formation also shows transmission of the ultrasound beam through the subject's body to the target organ.

The user interface 300 also includes a second window 320 presenting a schematic image of the abdomen and its internal portion. The schematic image presents a diagrammatic representation of structure (internal and/or external) of the abdomen that helps the user to identify and visualize the structure of the organ. The schematic image may be presented in a two dimensional (2-D) form. The schematic image also presents key structural features of the organ. In an instance internal portions of the organ may be provided with nomenclature so that the user can learn and understand the different portions of the organ. The user can therefore correlate the schematic image with the reference image 306 to learn the structure of the abdomen. The schematic image may be one or more static image frames or a video. Each image frame displays a schematic image of a particular portion of the organ. In another embodiment the second window 320 presents an ultrasound image of the organ along with a schematic image of the organ so that the user can correlate and understand the ultrasound image of the organ. In an embodiment the schematic image may be displayed in a single frame in the second window 320. It will be envisioned that content displayed in the first window 310 and the second window 320 may not be limited to the one or more demonstration image clips described above and thus may include contents that guide the user to perform the imaging procedure.

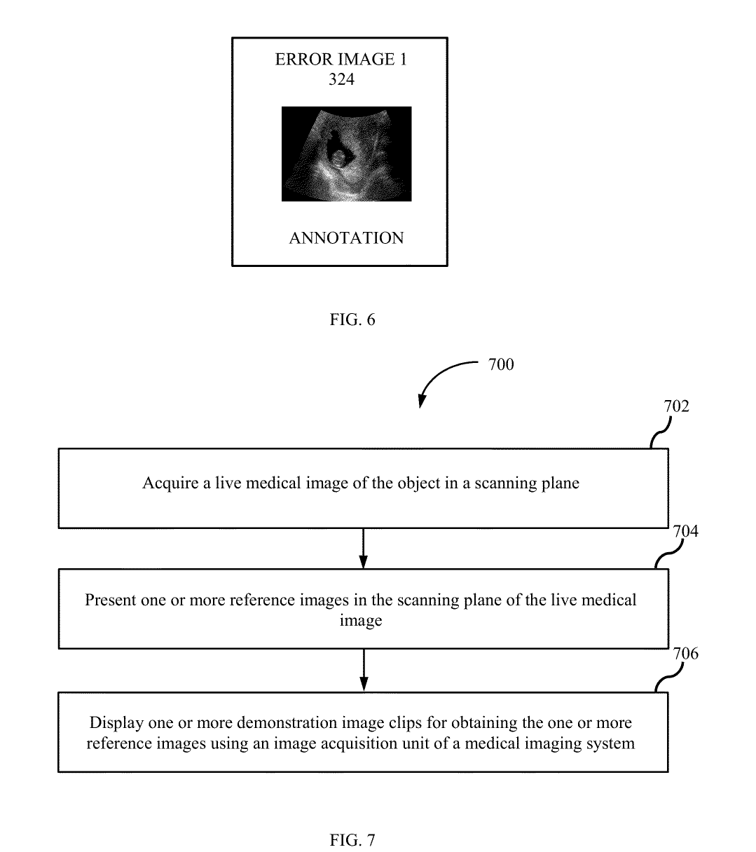

The user interface 300 also presents multiple error image clips. In an embodiment these error image clips may be displayed when an error image icon 322 is selected by the user. The error image clips such an error image 324, an error image 326, an error image 328 and an error image 330 may be displayed in the user interface 300 as shown in FIG. 4. An error image clip includes one or more images indicating error conditions that occur while using an image acquisition unit for acquiring one or more reference images. More specifically the error image clip presents one or more error images that may be obtained when a user attempts to acquire a reference image. These error images may be obtained based on past errors that were performed by different users while attempting to acquire the reference image. Thus more error images may be presented in the user interface 300 once time passes. It will be envisioned that the user interface 300 may display more error images in addition to the four error images displayed in FIG. 4. The user can view these error images and select an error image that is closer to the live medical image 302 acquired. For instance the user may select the error image 324 as close to the live medical image 302. The error image 324 includes a set of instructions indicating steps that need to be performed to obtain the reference image 306 if the error image 324 is acquired as the live medical image 302. The set of instructions may be provided as an annotation to the error image 324 as shown in FIG. 6. For instance the set of instructions may indicate that the image acquisition unit such as the image acquisition unit 202 needs to be rotated by maintaining at an angle 30°. This is because the error image 324 may be obtained when the image acquisition unit is used in an incorrect scanning plane. The user performs the presented set of instructions to acquire the reference image. The set of instructions may be overlaid on the error image 324 that can be read by the user and accordingly the image acquisition unit may be adjusted. The set of instructions associated with the error image 324 may be presented in any other form such as an audio. The audio may be activated when the error image 324 is selected. The user may select one or more error images at a time that is close to the live medical image 302. Then the user understands the set of instructions associated with these error images and accordingly move the image acquisition unit to acquire the reference image 306.

FIG. 7 illustrates a method 700 of assisting a user in acquiring a medical image of an object using a medical imaging system in accordance with an embodiment. The object may be a subject's body on which an image acquisition unit of the medical imaging system may be positioned by the user to acquire the medical image. At step 702 a live medical image of the object is acquired. The live medical image is obtained in a scanning plane. The scanning plane depends on an imaging procedure that needs to be performed on the subject's body. The user selects the scanning plane based on his knowledge of the imaging procedure and performs the acquisition of the live medical image. In order to determine whether the live medical image acquired is correct then one or more reference images are presented in a user interface of the medical imaging system at step 704. The one or more reference images are associated with the scanning plane of the live medical image. In another embodiment at least one reference image may be associated with a correct scanning plane associated with the imaging procedure to be performed or selected by the user. The user can view the at least one reference image and adjust the image acquisition unit to align to the correct scanning plane for acquiring the at least one reference image. In order to provide further assistance to the user one or more demonstration image clip are also displayed in the user interface for obtaining the one or more reference images at step 706. The one or more reference images and the one or more demonstration clips are displayed along with the live medical image.

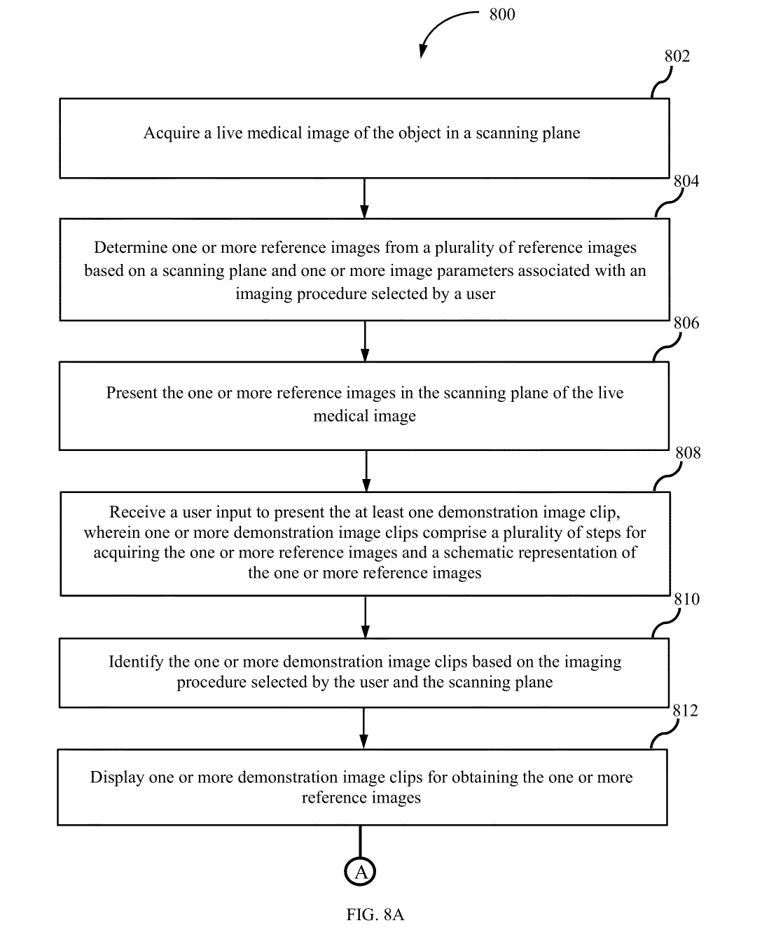

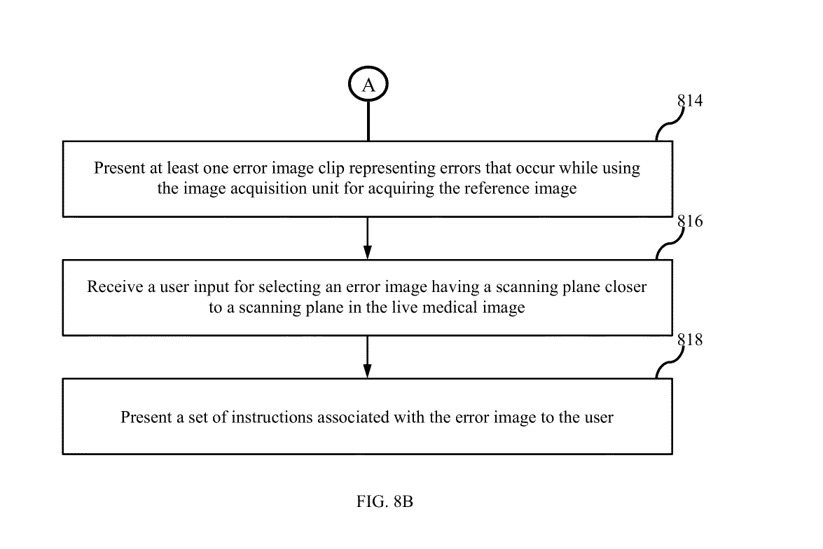

FIGS. 8A and 8B illustrate a method 800 of assisting a user in acquiring a medical image of an object using a medical imaging system in accordance with another embodiment. At step 802 a live medical image of the object is acquired. The live medical image is obtained in a scanning plane. The scanning plane depends on an imaging procedure that needs to be performed on the subject's body. The user selects the scanning plane based on his knowledge of the imaging procedure and performs the acquisition of the live medical image. Based on the scanning plane of the live medical image and one or more image parameters associated with the imaging procedure one or more reference images are determined from a plurality of reference images at step 804. For instance the imaging parameters may include biparietal diameter (BPD), head circumference (HC), abdominal circumference (AC) and femur diaphysis length (FDL) that need to be analyzed for determining a fetal geometry and wellbeing of a subject. Once the one or more reference images are determined then they are presented to the user through the user interface at step 806. The one or more reference images are associated with the scanning plane of the live medical image. In another instance one or more reference images may be associated with a scanning plane related to the imaging procedure selected by the user. In this case the scanning plane of the live medical image may not be accurate and hence the one or more reference images help the user in identifying a correct scanning plane.

At step 808 a user input is received for presenting one or more demonstration image clips. The one or more demonstration image clips are identified based on the imaging procedure selected by the user and the scanning plane at step 810. A demonstration image clip includes multiple steps involved in acquiring the one or more reference images using the image acquisition unit and a schematic representation of the one or more reference images. The one or more demonstration image clips are then displayed for obtaining the one or more reference images using the image acquisition unit at step 812. The one or more demonstration image clips may be displayed along with the one or more reference images and the live medical image. These demonstration clips help the user to adjust and/or move the image acquisition unit to obtain the reference images. If the user is a trained technician then the user can easily recognize the steps displayed and adjust the image acquisition unit to acquire the reference images. Whereas a novice user can view the demonstration image clips and learn image acquisition steps that need to performed and get trained for performing the imaging procedure. Thus the demonstration image clips act as a training guidance for the user of the medical imaging system. The demonstration image clips may be shown in multiple display windows. A window displays positioning of the image acquisition unit on the subject's or patient's body. The positioning of the image acquisition unit may be presented in multiple image frames.

Another window presents a schematic image of an organ of the subject. The schematic image presents a diagrammatic representation of structure (internal and/or external) of the organ that helps the user to identify and visualize the structure of the organ. The schematic image may be presented in a two dimensional (2-D) form. The schematic image also presents key structural features of the organ. In an instance internal portions of the organ may be provided with nomenclature so that the user can learn and understand the different portions. The user can therefore correlate the schematic image with the reference image to learn the structure of the organ. The schematic image may be one or more static image frames or a video. Each image frame displays a schematic image of a particular portion of the organ. In another embodiment this window presents an ultrasound image of the organ along with a schematic image of the organ so that the user can correlate and understand the ultrasound image of the organ. In an embodiment the schematic image may be displayed in a single image frame or in multiple image frames.

Further multiple error image clips are also presented in the user interface at step 814. An error image clip includes one or more images indicating error conditions that occur while using an image acquisition unit for acquiring one or more reference images. More specifically the error image clip presents one or more error images that may be obtained when a user attempts to acquire a reference image. These error images may be obtained based on past errors that were performed by different users while attempting to acquire the reference image. Thus more error images may be presented in the user interface once time passes. The user can view these error images and select an error image that is closer to the live medical image. The selection of the error image is received as a user input at step 816. The error image is presented along with a set of instructions at step 818. The set of instructions indicates steps that need to be performed to obtain the reference image if the error image is acquired as the live medical image. The set of instructions may be provided as an annotation to the error image. For instance the instruction may indicate that the image acquisition unit such as the image acquisition unit needs to be rotated by maintaining an angle 30°. This is because the error image may be obtained when the image acquisition unit is used in an incorrect scanning plane. The user performs the presented set of instructions to acquire the reference image. The set of instructions may be overlaid on the error image that can be read by the user and accordingly the image acquisition unit may be adjusted. The set of instructions associated with the error image may be presented in any other form such as an audio. The audio may be activated when the error image is selected. The user may select one or more error images at a time that is close to the live medical image. Then the user understands the set of instructions associated with these error images and accordingly move the image acquisition unit to acquire the reference image.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The methods described in conjunction with FIGS. 10 and 11 can be performed using a processor or any other processing device. The method steps can be implemented using coded instructions (e.g., computer readable instructions) stored on a tangible computer readable medium. The tangible computer readable medium may be for example a flash memory, a read-only memory (ROM), a random access memory (RAM), any other computer readable storage medium and any storage media. Although the method of providing imaging assistance to a user of the medical imaging system for acquiring medical images is explained with reference to the flow chart of FIGS. 10 and 11, other methods of implementing the method can be employed. For example, the order of execution of each method steps may be changed, and/or some of the method steps described may be changed, eliminated, divide or combined. Further the method steps may be sequentially or simultaneously executed for providing imaging assistance to a user of the medical imaging system for acquiring medical images.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A medical imaging system comprising:
an image acquisition unit configured to acquire a live medical image of an object in a scanning plane;
an imaging assistance unit configured to present at least one of:
at least one reference image in the scanning plane of the live medical image; and
at least one demonstration image clip for obtaining the at least one reference image using the image acquisition unit; and
a display unit communicably coupled to the image acquisition unit and the imaging assistance unit, wherein the display unit is configured to display the at least one reference image and the at least one demonstration image clip along with the live medical image.

2. The medical imaging system of claim 1, wherein the imaging assistance unit receives a user input for presenting the at least one demonstration image clip, wherein at least one demonstration image clip comprise a plurality of steps for acquiring the at least one reference image and a schematic representation of the at least one reference image.

3. The medical imaging system of claim 2, wherein a demonstration image clip of the at least one demonstration image clip comprises at least one image frame, the at least one image frame presents functioning of the image acquisition unit for acquiring the at least one reference image and a structure of the object.

4. The medical imaging system of claim 3, wherein the display unit is configured to display the at least one demonstration image clip in at least one viewing window.

5. The medical imaging system of claim 1, wherein the imaging assistance unit is further configured to:
determine the at least one reference image from a plurality of reference images based on a scanning plane and at least one image parameter associated with an imaging procedure selected by a user; and
identify the at least one demonstration image clip based on the at least one image parameter and the scanning plane.

6. The medical imaging system of claim 5, wherein the imaging assistance unit is further configured to present at least one error image clip representing errors conditions that occur while using the image acquisition unit for acquiring the at least one reference image, wherein an error image clip of the at least one error image clip comprises a plurality of error images.

7. The medical imaging system of claim 6, wherein the imaging assistance unit is further configured to annotate each error image of the at least one error image with a set of instructions for acquiring the at least one reference image with respect to each error image.

8. The medical imaging system of claim 7, wherein the imaging assistance unit is further configured to:
receive a user input for selecting an error image having a scanning plane closer to a scanning plane in the live medical image; and
present the set of instructions associated with the error image to the user.

9. The medical imaging system of claim 1, wherein the medical imaging system is an ultrasound imaging system.

10. A method of assisting a user in acquiring a medical image of an object using a medical imaging system, the method comprising:
acquiring a live medical image of the object in a scanning plane;
presenting at least one reference image in the scanning plane of the live medical image; and
displaying at least one demonstration image clip for obtaining the at least one reference image using an image acquisition unit of the medical imaging system, wherein the at least one reference image and the at least one demonstration image clip are displayed along with the live medical image.

11. The method of claim 10, further comprising:
receiving a user input to present the at least one demonstration image clip, wherein at least one demonstration image clip comprises a plurality of steps for acquiring the at least one reference image and a schematic representation of the at least one reference image.

12. The method of claim 10, further comprising:
determining the at least one reference image from a plurality of reference images based on a scanning plane and at least one image parameter associated with an imaging procedure selected by a user; and
identifying the at least one demonstration image clip based on the imaging procedure selected by the user and the scanning plane.

13. The method of claim 10, further comprising:
presenting at least one error image clip representing errors that occur while using the image acquisition unit for acquiring the reference image, wherein an error image clip of the at least one error image clip comprises a plurality of error images.

14. The method of claim 13, further comprising:
receiving a user input for selecting an error image having a scanning plane closer to a scanning plane in the live medical image; and
presenting a set of instructions associated with the error image to the user, wherein the set of instructions is for acquiring the reference image with respect to each error image.

15. The method of claim 14, wherein presenting the set of instructions associated with the error image comprises annotating each error image of at least one error image with the set of instructions.
